(19) United States
(12) Patent Application Publication
(10) Pub. No.: US 2017/0040715 A1
(43) Pub. Date: Feb. 9, 2017

(54) ELECTRICAL WIRING CLAMPING DEVICE BEING APPLIED IN ALL ELECTRICAL METERING BASES ON INSULATOR BETWEEN BASE AND CLAMP

(71) Applicant: Alejandro Archundia Stefanonni, Puebla (MX)

(72) Inventor: Alejandro Archundia Stefanonni, Puebla (MX)

(21) Appl. No.: 15/305,318

(22) PCT Filed: Apr. 15, 2015
(86) PCT No.: PCT/MX2015/000063

§ 371 Date: Oct. 19, 2016

(30) Foreign Application Priority Data
May 15, 2014 (MX) MX/U/2014/000207

(51) Int. Cl. H01R 4/30; H02G 3/04

(52) U.S. Cl. CPC H01R 4/302; H02G 3/04

(57) ABSTRACT

A one-piece electrical wiring clamping device is described, suitable for use in all electricity meter bases, said device comprising: a single metal piece having at least two borings for passing through of a clamping screw; a power cord's clamping area; a rectangular nut having at least two borings for passing through of a clamping screw; a rectangular washer having at least two borings for passing through of a clamping screw; at least two clamping screws for securing the power cord; at least two edging-shaped folds adjacent to the clamping area; a securing clip; and at least two borings for securing a single metal piece to the insulating bakelite base.

### TECHNICAL FIELD OF THE INVENTION

It is envisioned this clamping device be adaptable to all electrical metering bases known as electricity meters, Watt-hour meters, power meters, electric counters or power consumption meters, of which this clamping device, taken together with an electrical metering base, allows the power-consumption metering device in a circuit or an electric power service to operate adequately. This device is adaptable to existing and installed meter devices, which will soon be for sale and for new consumers. Allowing for an excellent conduction quality and risk elimination due to short circuits, wiring overheating or power leakage.

### BACKGROUND OF THE INVENTION

Currently, electrical metering bases identified as “4 or 5-prong plug outlet sockets, 100 amps” have design differences which, when used in electrical installations, produce overheating problems in a knife-type main switch 100 amp wire. These actual deficiencies in meter-devices bases are identified as: The fixing is only done by means of a screw on both sides, and 3-piece or 2 piece actual design allows for the screws currently being used to cover a minimum clamping surface, over time causing the power cord to loosen, resulting in an inefficient energy carrier and overheating generating a short circuit and therefore, the electrical installations supervision and maintenance work must be carried out again.

### BRIEF DESCRIPTION OF THE FIGURES

FIG. 1 illustrates a one piece clamping device finished as embodiment A.

FIG. 2 illustrates a one piece clamping device as embodiment B.

FIG. 3 illustrates a one piece clamping device as a 5-prong embodiment C.

FIG. 4 illustrates a top view for the insulating bakelite.

FIG. 5 illustrates a bottom view for the insulating bakelite.

FIG. 6 illustrates the screw for the different fastening systems.

FIG. 7 illustrates the electrical metering base without bakelite nor clamping device.

FIG. 8 illustrates the rectangular washer with joining screws.

FIG. 9 illustrates the rectangular nut.

FIG. 10 describes the beginning of embodiment “A” in a top view illustrating the outline of original template and perimeter of the figure being cut in the first type-“A” usage embodiment.

FIG. 11 illustrates a top view of a perimeter cutting having a single piece being left.

FIG. 12 illustrates a top view of different folds and borings to be performed in embodiment “A”.

FIG. 13 illustrates a top view of first folds made in embodiment “A”.

FIG. 14 illustrates a side view of first folds to be made in embodiment “A”.

FIG. 15 illustrates a side view of first fastening system folds for the electricity meter.

FIG. 16 illustrates a side view of main folds for fastening the electricity meter terminal.

FIG. 17 illustrates a side view showing a correct form of fold for fastening the electricity meter terminals.

FIG. 18 illustrates a side view showing how a single-piece, producing the two different-sized rectangles figure should be.

FIG. 19 illustrates a side view of the boring symmetry on the “C”-shaped figure for fastening the electricity meter terminal.

FIG. 20 illustrates a side view where embodiment “A” 4^{th} drilling should be done.

FIG. 21 describes beginning of embodiment B with an outlined rectangular template.

FIG. 22 describes figure's appearance after being cut for the clamping device's right side.

FIG. 23 describes figure's appearance for clamping device's left side.

FIG. 24 describes the different bores and folds for being made in embodiment “B”.

FIG. 25 shows a side perspective of fold in embodiment B.

FIG. 26 illustrates a fold's side perspective for electricity consumption meter terminal fastening.

FIG. 27 shows a side view of the area where the double-fastening cable will be introduced.

FIG. 28 illustrates the form of the edging being made for electricity meter terminal fastening.

FIG. 29 illustrates a side view for the shape of the finished edging and the area for power cord fastening.

FIG. 30 illustrates a side view of the attachment for type-“B” clamping device.

FIG. 31 illustrates a side view showing the area for electricity meter terminal fastening.

FIG. 32 illustrates the threaded hole for the dual union with insulating bakelite.

FIG. 33 illustrates the starting template in embodiment “C”.

FIG. 34 illustrates the corresponding figure after having carried out the perimeter cutting.

FIG. 35 illustrates the different folds and bores being made for manufacturing the piece in its “C5 Terminal” embodiment.

FIG. 36 illustrates the first folds to be done for the meter device terminal and their coupling to the ground assembly.

FIG. 37 illustrates the area to power cord fold.

FIG. 38 illustrates the formed part and threaded hole for coupling with insulating bakelite.

FIG. 39 illustrates the edging for coupling with the electricity meter terminal.

FIG. 40 illustrates a top perspective view of the finished part being one-piece manufactured as a clamping device in embodiment “A” with its respective rectangular washer and nut assembled in the insulating material known as bakelite and its respective latch for electricity meter terminal fastening.

FIG. 41 illustrates a top perspective view of the finished part being one-piece manufactured as a clamping device in embodiment “B” with its respective rectangular washer and nut assembled in the insulating material known as bakelite and its respective latch for electricity meter terminal fastening.

FIG. 42 illustrates a top perspective view of the finished part being one-piece manufactured as a clamping device in embodiment “C” with its respective rectangular washer and nut assembled in the insulating material known as bakelite and its respective latch for electricity meter terminal fastening.

FIG. 43 illustrates the assembly on the electricity meter base in embodiment “A”.

FIG. 44 illustrates the assembly on the electricity meter base in embodiment “B”.

FIG. 45 illustrates the assembly on the electricity meter base in embodiment “C”.

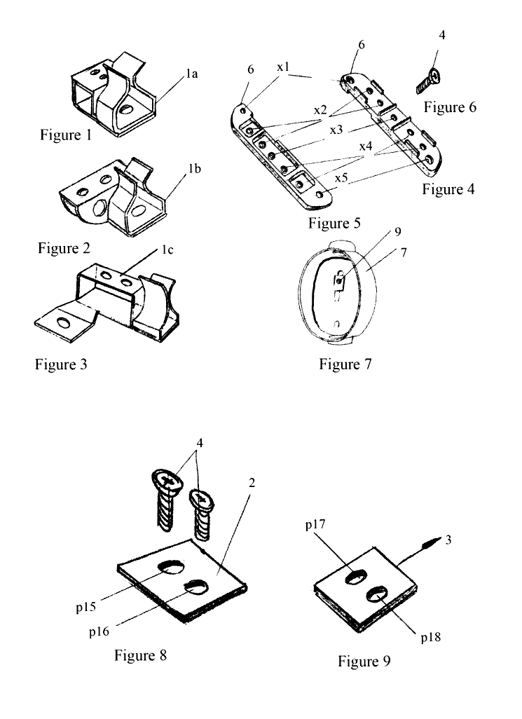

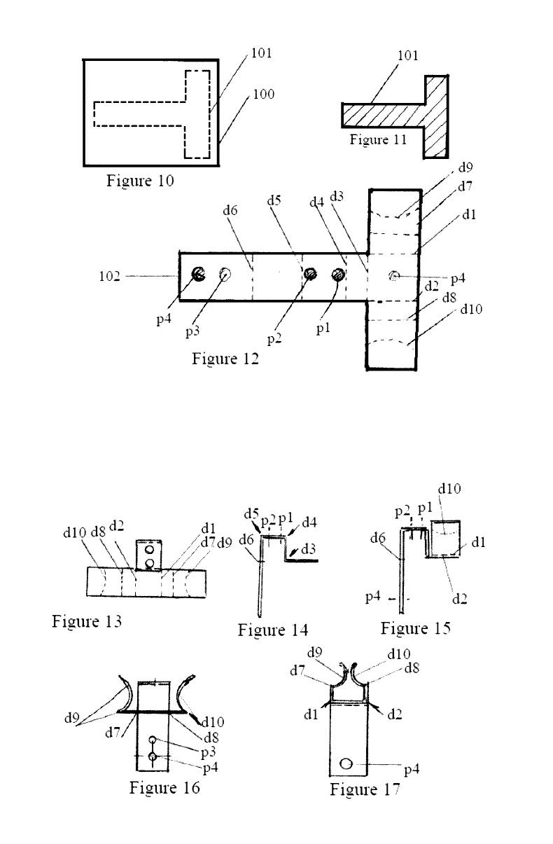

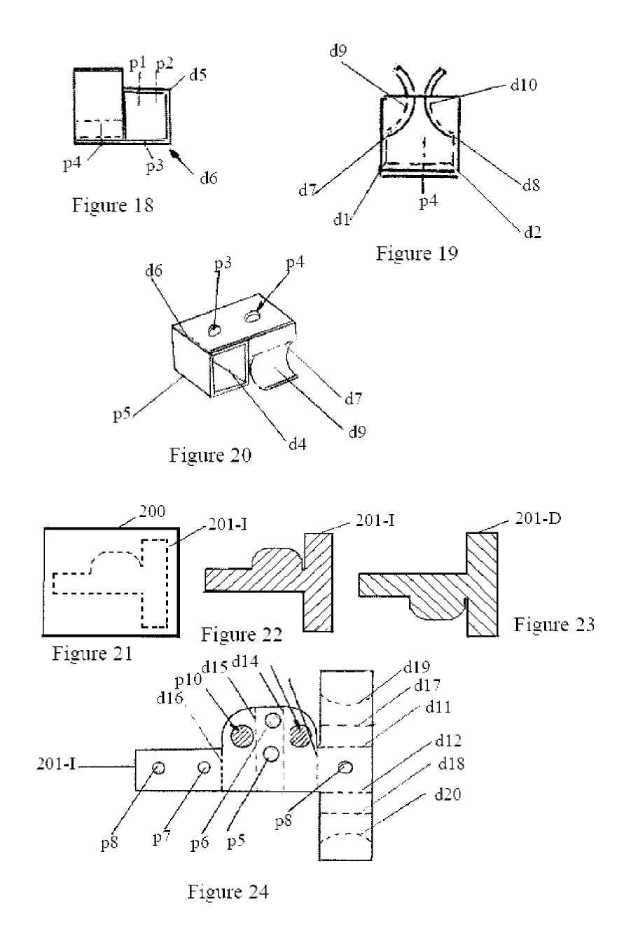

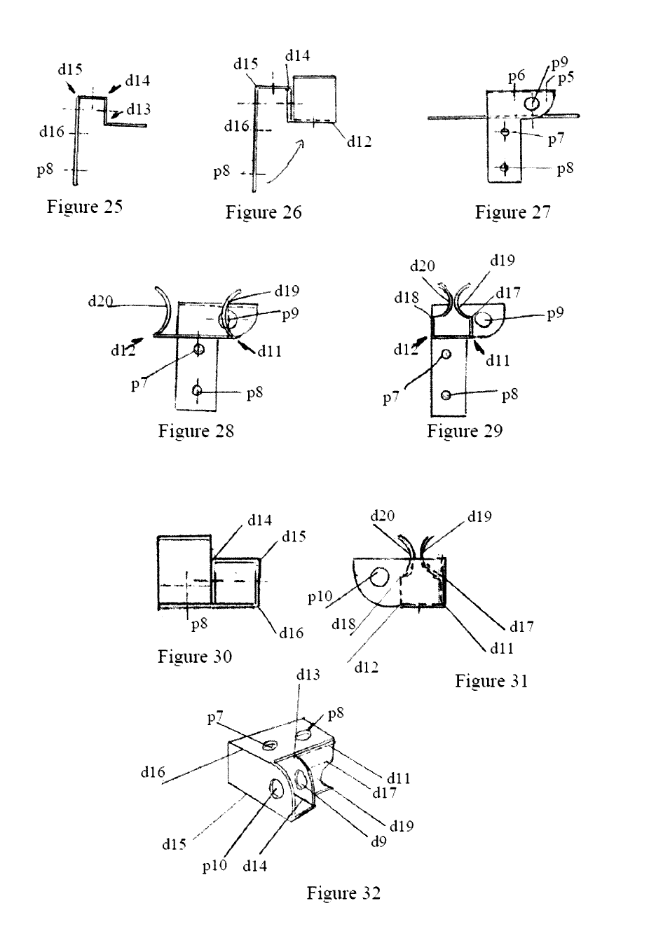

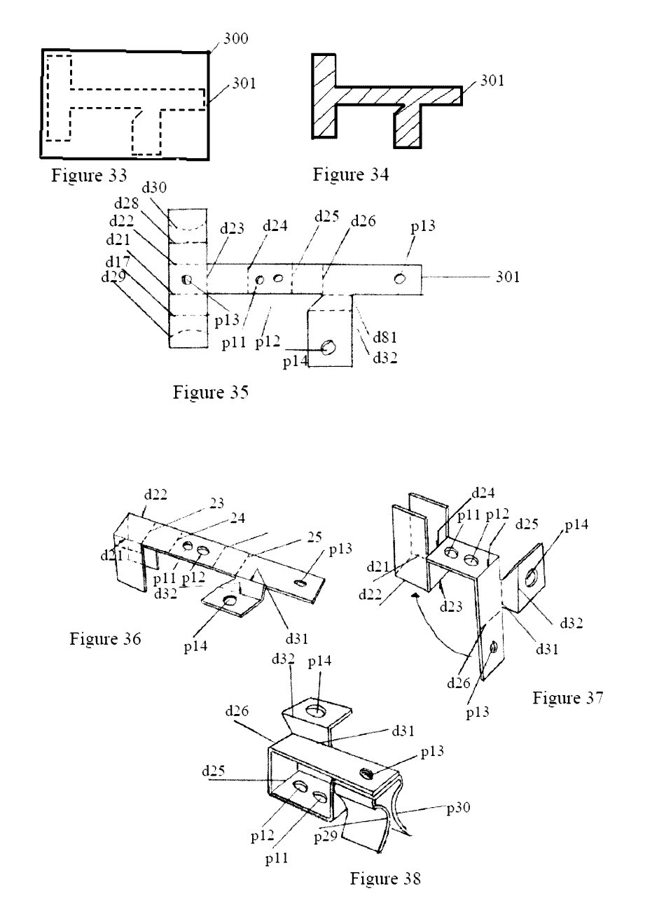

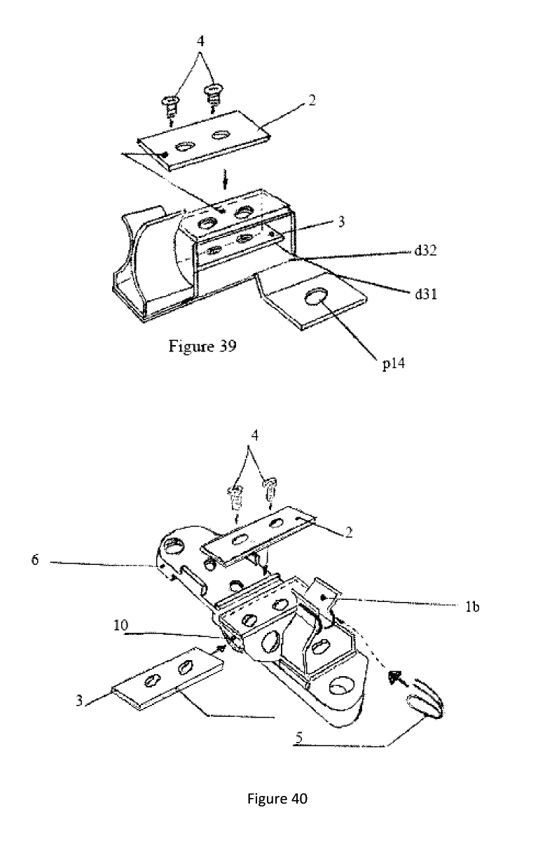

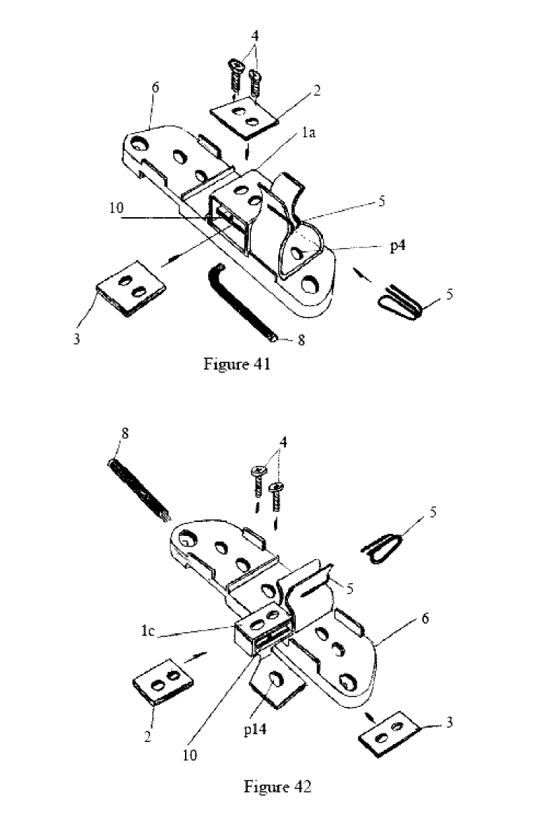

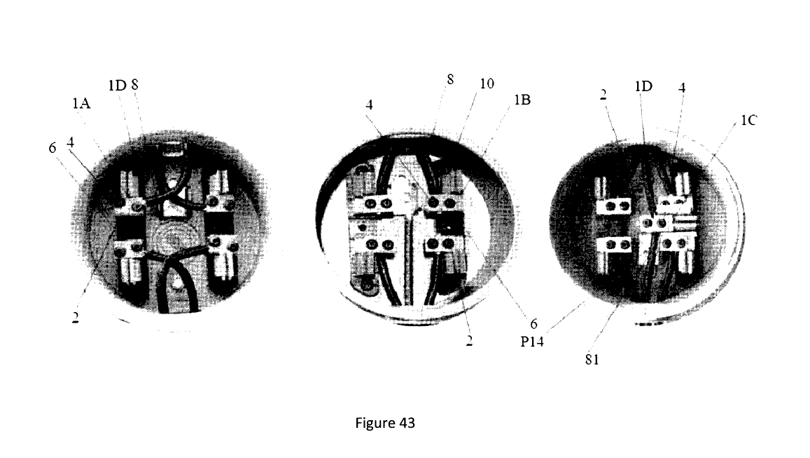

### BRIEF DESCRIPTION OF THE INVENTION

A first embodiment of the present invention is constituted by a one-piece electrical wiring clamping device for a electricity meter base wherein it is constituted by a single metal piece with at least two borings for passing through of the clamping screw located in the upper part, a clamping area for the power cord; a rectangular nut with at least two borings for passing through of the clamping screw, said nut located inside the power cord's clamping area; a rectangular washer with at least two borings for passing through of the clamping screw, located in the upper part of the power cord's clamping area; at least two clamping screws for securing the power cord, located at the top of the clamping area; at least two edging-shaped folds adjacent to the clamping area for receiving the meter device terminals, a securing clip located on at least the two edging-shaped folds; at least two holes for clamping of single metal piece to the insulating bakelite base located at the bottom of said single metal piece.

A second embodiment of the invention is constituted by a one-piece electrical wiring clamping device for a electricity meter base wherein it is constituted by a single metal piece with at least two borings for passing through of the clamping screw placed in the upper part, a clamping area for the power cord; a rectangular nut with at least two borings for passing through of the clamping screw, said nut located inside the power cord's clamping area; a rectangular washer with at least two borings for passing through of the clamping screw, located in the upper part of the power cord's clamping area; at least two clamping screws for securing the power cord, located at the top of the clamping area; at least two edging-shaped folds adjacent to the clamping area for receiving the meter device terminals, a securing clip located on at least the two edging-shaped folds; at least two holes for clamping of single metal piece to the insulating bakelite base located at the bottom of said single metal piece; a projection adjacent to power cord's clamping area, which is formed into the same single metal piece; at least one boring for passing through of power cord, said boring located on the projection adjacent to clamping area.

A third embodiment of the present invention is constituted by a one-piece electrical wiring clamping device for a electricity meter base wherein it is constituted by a single metal piece with at least two borings for passing through of the clamping screw placed in the upper part, a clamping area for the power cord; a rectangular nut with at least two borings for passing through of the clamping screw, said nut located inside the power cord's clamping area; a rectangular washer with at least two borings for passing through of the clamping screw, located in the upper part of the power cord's clamping area; at least two clamping screws for securing the power cord, located at the top of the clamping area; at least two edging-shaped folds adjacent to the clamping area for receiving the meter device terminals, a securing clip located on at least the two edging-shaped folds; at least two holes for clamping of single metal piece to the insulating bakelite base located at the bottom of said single metal piece, at least one flange to fifth adjacent the clamping area for electrical cable terminal which is formed of same single piece of metal; at least one boring for connecting the fifth terminal to the electricity meter base located on the fifth terminal flange.

### DETAILED DESCRIPTION OF THE INVENTION

The clamping device known as clamping device in its different usage variables to which said invention relates, prevents loosening of power cord in electricity meter bases known as Watt-hour meters. This present invention consists of one single piece with three different embodiments. These embodiments are assembled in an insulating bakelite (6) which has seven borings, these borings will couple the clamping devices (1A, 1B, 1C) via at least two screws (4), with a double-fastening configuration in their borings (x2, x4), likewise, the borings (x1, x5) allow coupling and fastening by means of screws (4) to the electrical metering base (7).

Initially, for the three embodiments described two rectangular cuts are made, wherein one of these cuts will function as a washer (102) wherein two borings are made according to the embodiment configurations (p15, p16) which allows the passing through of both screws (4) between the clamping device's clamping area (1A, 1B, 1C) and the rectangular nut (3) containing two threaded borings (p17, p18) allowing screwing of said parts and clamping according to the clamping area (10) for power cord (8) by tightening the screws (4) with the screwdriver.

Therefore, the first type-“A” embodiment will be described; by which the initial process will be detailed below, where a rectangular piece (100) is selected from the initial cut perimeter for obtaining a single piece for developing in its embodiment “A” (1A) outlining on the rectangle the cutout perimeter which will provide for a “T”-type figure; from which once the perimeter has been cut, part (101) is obtained. Subsequently, from FIG. 11, the borings and folds for being made can be identified, and once identified you can proceed drilling borings (p1, p2) which support the weight of clamping screws (4) for the rectangular washer (2) and rectangular nut (3). For obtaining a fastening on the insulating bakelite (6), two borings (p3, p4) are then performed to allow for a double clamping on insulating not allowing to rotate when being installed on the insulating bakelite, subsequently, the fold shape is contoured allowing to shape the electricity meter terminal fastening, this step begins with two 90° folds (d1, d2), then a 90° fold (d7, d8) is outlined to edging-shape with at least two 45° folds (d9, d10) for electricity meter terminals fastening. Once having these folds correctly, we proceed bending upwards 90 degrees (d3), subsequently a left-turn 90° fold (d4) is carried out, then another less than 90° fold is made to the left (d5) and finally another 90° fold for allowing the piece and fastening systems being closed with insulating bakelite (6), as this will produce the finished shape of type-“A” clamping device (1A). Once finished said clamping device (1A) which will allow the incorporation of the rectangular washer (2) and the rectangular nut (3) with the fastening of at least two screws (4) for power cord fastening (8) with a torque. Subsequently, a boring is performed for joining the openings (p4) which will allow fastening of the one-piece type-“A” clamping device (1A) and the double-fastening between the insulating bakelite (6). When finishing the designated process, it will provide a one-piece type-“A” clamping device (1A) wherein its use application is for the electrical wiring clamping (8).

Subsequently, once the type-“A” clamping device (1A) has been finished, the bakelite insulating assembly is performed (6), wherein is screwed into the borings (X3) with (p4, p3), the rectangular washer (2) is assembled afterwards with its respective nut (3), with the addition of at least two screws (4) for the power cord configuration (8). Subsequently, for fastening one of the four electricity meter terminals, a latch known as a securing clip is installed (5).

As a first embodiment, once the sub-assembly is finished, the installation of screws (4) in the borings proceeds (x1, x4) for integrating in the electricity meter base (7). As can be appreciated in the type-“A” clamping device embodiment (1A), the wiring clamping in a double-fastening single piece for the electrical wiring installed in the clamping area (13). To a torque, in such way its power cord double-fastening configuration (8) consists of the integration of a type-“A” clamping device (1A) with the rectangular washer (2) and both screws passing through the borings (p6, p5) for incorporation of threaded borings (p17, p18) for fixing and pressing on the power cord in the clamping area (10) contacting the rectangular nut (3). Subsequently, correct installation will be finished when pressing with the necessary tool according to the screw-head configuration according to the requested configuration.

As a second type-“B” embodiment; as in the previous rectangular piece (200), a cutting perimeter area is outlined providing a “T”-shaped figure with an “eclipse”-shaped adherence (201), once having the figure for forming the type-“B” clamping device, the different folds and borings to be made are defined, as well as the left to right side according to the location in the electrical metering base (201-I,201-D). Therefore, borings to be made are defined and the drillings to be made are identified (p5, p6), which will allow the passing-through of clamping screws (4) of rectangular washer (2) and rectangular nut(3) allowing the power cord fastening (8). These devices allow for a double-fastening for the electrical wiring with at least two screws (4) to installation, borings are performed subsequently for passing through of the power cord (p9) or (p10 optional) of which its design facilitates in time and form the power cord installation. In addition, borings are performed for enabling a double-fastening with insulating base known as bakelite not allowing it to rotate during its setting on the insulating material, regarding borings (p7, p8), the first boring to be performed is (p7), and a 90° upward fold is subsequently performed (d13), afterwards, another 90° fold (d14) is performed leftwards, similarly, a 90° fold is performed downwards (d15), from which remains the shape for the passing-through and fastening of electrical wiring. Subsequently, then proceeds to jointly carrying out the folds (d11, d12) which will allow to jointly make another fold simultaneously (d17, d18) that will let to produce two folds for obtaining the correct 45° edging (d19, d20) for the electricity meter terminals fastening Subsequently, the last fold (d16) is performed, which will allow shaping of the type-B clamping device (1B) and the last boring (p8) is performed which will allow the type-“B” clamping device fastening together with the insulating bakelite (6). At the term of said process, the one-piece type-“B” clamping device (1B) will be obtained.

Subsequently, once the type-“B” clamping device (1B) has been finished, the bakelite insulating assembly is performed (6), wherein the boring (x2) is screwed (4) onto (p7, p8), the rectangular washer (2) is assembled afterwards with its respective nut (3), with the addition of the screws (4) for the power cord fastening (8). Subsequently, for fastening one of the four electricity meter terminals, a latch known as a securing clip is installed (5).

For finishing the “second” embodiment, once the embodiment “B” (1B) sub-assembly is finished, the installation of screws (4) in the borings proceeds (x1, x4) for integrating in the electricity meter base (7). As can be seen from the type-“B” clamping device (1B) embodiment of the one-piece wiring clamping with double-fastening for electrical wiring installed in the clamping area (10) torque, in such a way that power cord double-fastening configuration (8) passes through the openings (p5,p6) integrating the type-“B” clamping device (1B). Such fixing consists of a rectangular washer incorporation (2) and two screws (4) passing through the borings (p15, p16) for incorporating threaded borings (p17, p18) for the fixing and pressing on the power cord in the clamping area (10) in contact with the rectangular nut (3). Subsequently, correct fixing will be finished when tightening with the necessary tool according to the screw-head configuration according to the requested configuration.

The third type-“C” embodiment is the clamping device for the fifth terminal which will be allowed being installed or adapted to the 5-prong meter-devices bases, ensuring, as well as the two previous embodiments, the same fastening and in one-piece, to accomplish this it is done starting from a rectangular dish (300), a contour perimeter is performed (301) to start the cutting which will shape the “C”-type clamping device once the perimeter cutting (301) is made to the rectangle (300), an inverted “F”-shaped figure is obtained which will allow shaping of “C”-type clamping device (1C), when getting this figure, the corresponding folds and borings are set to shape the “C”-type clamping device (1C); so borings which allow passing-through of screws and the clamping of rectangular washer are identified together with rectangular nut (p11, p12), and subsequently, drilling (p13) is identified, which will allow the fastening with insulating bakelite (6). Likewise, the boring (p14) is identified to be made, which will allow screwing the configuration through ground-connection (9) with the electrical metering base (7).

Subsequently, a downwards 90° fold is jointly done (d21, d22), and another 90° downward fold (d23) is later performed. Similarly, a 90° fold (d24) to the right and other one upwards (d25) are performed. Therefore, for closing the figure a fold (d26) is performed from which the figure remains for passing through and fastening of the electric wiring. Subsequently, the edged-folds (d29, d30) proceed to being jointly made, which will allow to simultaneously jointly elaborate another fold (d27, d28) which will let producing two folds for obtaining the correct 45° edging (d29, d30) for the electricity meter terminals fastening. Additionally, a 45° fold is performed (d31) or another of 90° (d32) which will allow for a ground-connection (9) to the electrical metering base (7) and finally the last opening (p13) is performed which will allow the clamping of the type-“C” clamping device (1C) together with the insulating bakelite. At the term of said process, the one-piece type-“C” clamping device (1C) will be obtained, identified as the “5-prong” clamping device (1C).

Subsequently, once the type-“C” clamping device (1C) has been finished, the bakelite insulating assembly is performed (6), wherein the boring (x5) is screwed (4), and the rectangular washer (2) is assembled afterwards with its respective nut (3), with the addition of the screws (4) for the power cord fastening (8). Subsequently, for fastening one of the four electricity meter terminals, a latch known as a securing clip is installed (5).

For finishing the “third” embodiment, once the embodiment “C” (1C) sub-assembly is finished, the installation of screws (4) in the borings proceeds (x1, x4) for integrating in the electricity meter base (7). Likewise, opening (1) is screwed by grounding connection (9) to the electrical metering base (7), as can be seen in the “C”-type clamping device (1C) embodiment, with respect to the wiring clamping in a one-piece wiring clamping with double-fastening for electrical wiring installed in the clamping area (10).

1. A one-piece electrical wiring clamping device for an electricity meter base, comprising:
a single metal piece with at least two borings for passing through of the clamping screw, placed on upper part;
a power cord's clamping area;
a rectangular nut with at least two borings for passing through of the clamping screw, said nut located inside the power cord's clamping area;
a rectangular washer with at least two borings for passing through of the clamping screw, located in the upper part of the power cord's clamping area;
at least two clamping screws for clamping the power cord, located in the upper part of the clamping area;
at least two edging-shaped folds adjacent to clamping area for receiving the meter device terminals;
a securing clip located on at least the two edging-shaped folds;
at least two borings for fastening a single metal piece to the insulating bakelite base, located at the bottom of said single metal piece.

2. The one-piece electrical wiring clamping device for an electricity meter base according to claim 1, which further comprises:
a projection adjacent to the power cord's clamping area, which is formed on the same single metal piece.

3. The one-piece electrical wiring clamping device for an electricity meter base according to claim 2, which further comprises:
at least one boring for passing through of power cord, said boring is located in the projection adjacent to the clamping area.

4. The one-piece electrical wiring clamping device for an electricity meter base according to claim 1, which further comprises:
at least one fifth terminal flange adjacent to the power cord's clamping area, which is formed from the same single metal piece.

5. The one-piece electrical wiring clamping device for an electricity meter base according to claim 4, which further comprises:
at least one boring for connecting the fifth terminal to the electrical metering base located at the fifth terminal flange.
